(19) United States
(12) Patent Application Publication
(10) Pub. No.: US 2010/0253499 A1
(43) Pub. Date: Oct. 7, 2010

(54) LIGHTING CONTROL SYSTEM

(75) Inventors: Daniel B. Haab, Springville, UT (US); Vaughn R. Staheli, Payson, UT (US); Jim Grady, Elko, NV (US)

Correspondence Address: HUSCH BLACKWELL SANDERS LLP, 190 Carondelet Plaza, Suite 600, ST. LOUIS, MO, 63105, US

(73) Assignee: HELLA, INC., Peachtree City, GA (US)

(21) Appl. No.: 12/716,364

(22) Filed: Mar. 3, 2010

Related U.S. Application Data
(60) Provisional application No. 61/157,029, filed on Mar. 3, 2009.

(51) Int. Cl. B60Q 1/52

(52) U.S. Cl. 340/471

(57) ABSTRACT

A method of controlling a plurality of lights on a vehicle lighting system provides a first and second light having a first and second processor. Each is in operative communication with a bus establishing an operative communication between the first and second processor. A master processor is arbitrated among the first and second processors. Thereafter the master processor signals the first and second processors to execute a preconfigured flash pattern.

### CROSS-REFERENCE TO RELATED APPLICATION

This application claims the benefit of and priority to U.S. Provisional Patent Applications Ser. No. 61/157,029, filed Mar. 3, 2009, entitled LIGHTING CONTROL SYSTEM, which application is hereby incorporated by reference to the extent permitted by law.

### BACKGROUND OF THE INVENTION

1. Field of the Invention

The present invention is in the field of lights for emergency vehicles, construction vehicles, construction sites and the like and in the field of controlling groups of such lights.

2. Related Art

For emergency vehicles, construction vehicles and construction sites, it is desirable to control groups of lights so that they illuminate and/or flash in a desired, preconfigured sequence or pattern. For example some flash control patterns simultaneous flash a group of lights to increase visibility. It is also possible to communicate with personnel by designating a particular flash pattern to be a signal for certain actions, such as an emergency alert or evacuation.

Prior art systems for controlling flash patterns and sequences for groups of lights have been complex, cumbersome and expensive. Generally, individual pairs of lead wires must be run to individual lights and gathered in a wiring harness to communicate with a separate central control apparatus. Moreover, installation of such a control device in individual vehicles has been time consuming, expensive and provided limited functionality.

### SUMMARY OF THE INVENTION

The present invention is a control system for a group of lights, such as are used on emergency or construction vehicles. The invention obviates a need for a central control apparatus and processor. The invention includes a microprocessor of minimal complexity associated with each of a plurality of lights. The microprocessors are put in operative communication with one another by a single communication line.

Each light and its associated microprocessor have a unique identifying code. Each microprocessor is preconfigured to have a configuration mode, an arbitration mode and an operational mode. When the group of lights is turned on, each of the microprocessors enters the arbitration mode. In arbitration mode, the microprocessors iteratively review their unique identifiers in order to designate a master light/processor combination. Once the master light/processor has been designated, that light/processor enters operation mode, retrieves stored sequencing configurations and signals a group or groups of lights to execute the stored flash patterns.

In configuration mode, any of a variety of signal patterns may be selected by an installer. Additionally, any of a variety of groups of lights may be designated by an installer. These may be arranged in a preconfigured hierarchy, or may be put at an operator's control through an operator interface such as a switch panel. In operation mode, the master light/processor executes the preconfigured light flashing sequences. The non-master processors receive the signals and flash their associated lights according to the signal instructions.

The system is adaptable for use with lights having processors that are outside the unique identifier system of the present invention and also for use with lights without any processors whatsoever. This is done simply by providing a processor and associating it with any such light and putting it in operative communication with that light. Once so connected, the light outside the system may be controlled through its associated processor in the same fashion as lights provided with processors from within the system. The provided processors also have unique identifying numbers consistent with the system of lights within the group having unique identifiers.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of the lighting control system.

FIG. 2 is a flow chart of an arbitration routine.

FIG. 3 is a flow chart of a configuration routine.

FIG. 4 is a flow chart of an operation routine.

FIG. 5 is a block diagram of an alternative embodiment.

### DETAILED DESCRIPTION OF THE PREFERRED EMBODIMENTS

The following description of the preferred embodiment(s) is merely exemplary in nature and is in no way intended to limit the invention, its application, or uses.

Hardware:

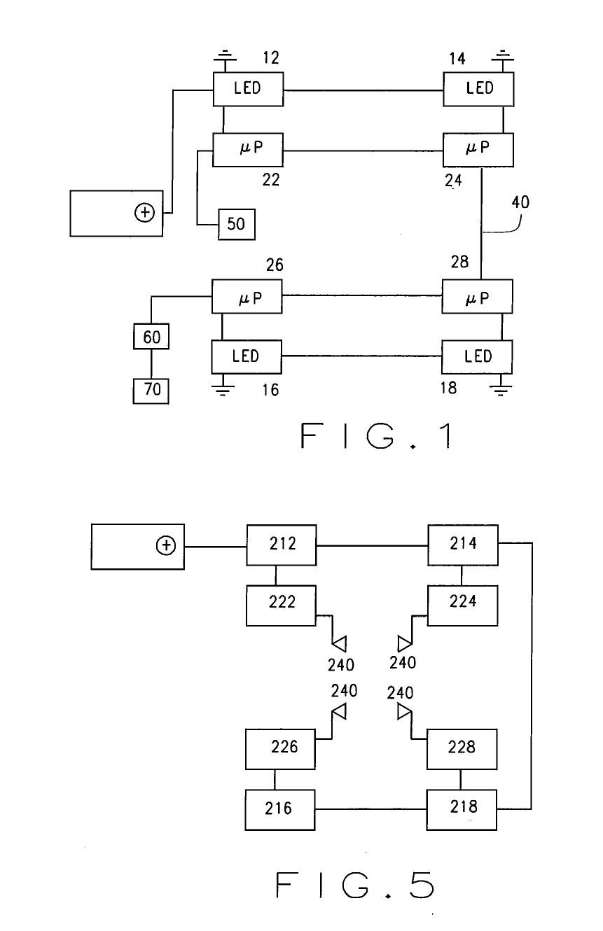

The system of the present invention will include a plurality of lights within a single light system. This system is usually mounted on a single vehicle such as a police car, construction vehicle or a refuse truck. In FIG. 1, by way of example, four lights are shown as installed as a vehicle light system. The lights used are LEDs 12, 14, 16 and 18. Each LED light may be a beacon or a light bar having a plurality of lights therein. However, in each case the light 12, 14, 16 or 18 has associated with it a microprocessor 22, 24, 26 or 28. For those lights manufactured according to the present invention, microprocessors will be built into and assembled within the same housing and base as the overall light 12, 14, 16 or 18. Each microprocessor within lights manufactured according to the present invention will have a unique identifying serial number. The system may also work with lights manufactured outside the system and method of the present invention, as will be described in greater detail below.

The LED lights are powered by a battery 20 through a power wire 30 and each LED is grounded. Each microprocessor 22, 24, 26 and 28 is connected with one another by a control wire 40. The control wire 40 acts as a bus, but may be a simple electrically conductive wire. The bus 40 has a stepped down power source so that bus 40 may have a voltage potential or not, and may thus be read by any processor in operative communication with it as a 1 or a 0. Each processor 22, 24, 26 and 28 is in operative communication with bus 40, and not otherwise in operative communication with the other processors.

FIG. 1 also discloses a user interface 50 which may be used by an installer to configure the system and thereafter used by an operator to operate the system of the present invention. FIG. 1 also depicts an add-on controller 60, which may be installed and associated with a light having no processors, including incandescent lights, headlights, breaker tail lights or including lights having processors, but being outside the system of uniquely identified processors of the present invention. This add-on processor function will be more fully described below.

Arbitration:

A particular light flashing sequence or pattern may be preconfigured for a light or a single group of lights. However, in order to have the capability of designating more than one group of lights, with the different groups to flash at different times or execute different patterns, a single processor must control when the various groups will execute their various flash patterns and the order in which the groups will do so. Prior art systems disadvantageously achieve this by simply providing an additional microprocessor in a separate control unit and then laboriously establishing direct lines to each light over which control signals could be sent. The present invention eliminates these parts and steps by designating as a master controller one of the controllers already preexisting in the lights of the present system. This designation of a master processor among a plurality of lights in a system, usually a single vehicle, is referred to herein as arbitration.

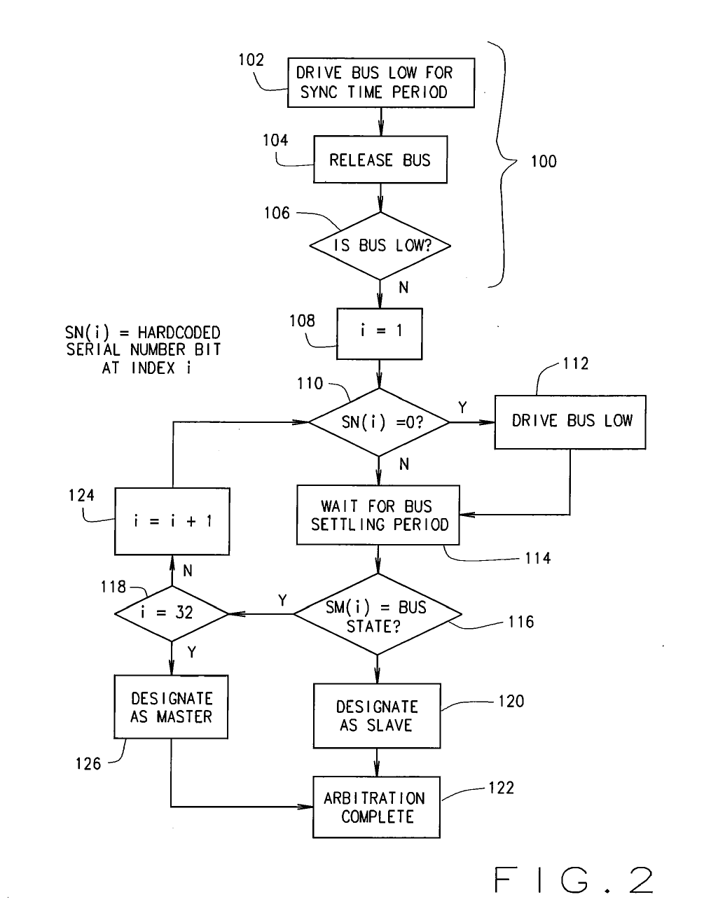

FIG. 2 is a flow chart depicting the arbitration system of the present invention. The arbitration system designates as a master processor one microprocessor among a plurality of microprocessors connected to the bus 40. After designation, groups of lights will be illuminated in a preconfigured order and will execute a particular preconfigured flash pattern, in response to signals from the master controller.

The flow chart depicted in FIG. 2 will be executed individually by each microprocessor connected to the buss 40 in the vehicle lighting system. Each microprocessor 22, 24, 26 and 28 is capable individually of driving the bus 40 to a low voltage or zero value, regardless of whether or not any of the other processors are also driving bus 40 to a low, zero value. Bus 40 is configured to revert automatically to a high or 1 value, i.e., having a voltage potential, unless at least one of the processors is holding it low, at zero value. In FIG. 2, the group of steps designated 100 serves to synchronize the subsequent arbitration activity of all the processors in the vehicle system, which are otherwise asynchronous. When the system is turned on by an operator, the processors all drive the bus low for a preconfigured period of time at step 102. After the preconfigured period of time in step 104 all the processors release the bus. After another preconfigured period of time, each processor checks the bus to see if it is still being held at the low or zero voltage value by any of the processors at step 106. If all of the processors have completed their time period for holding the bus low and released it, then the bus will revert to its high voltage value of 1 and the processors are synchronized and the arbitration process may begin. Hence, step 106 is to determine if the bus is low and if not, being in the high state, the arbitration process begins.

At step 108, a first bit is examined by each processor. Each processor in the depicted embodiment has a unique serial number. The serial number is comprised of 32 bits. 32 bits corresponds to 4.2 billion uniquely identifying serial numbers (4,294,967,296 to be exact). Accordingly, for all LED microprocessors manufactured according to the present invention, each microprocessor will have a unique serial number, thus preventing the possibility of any two identical serial numbers occurring in the same vehicle system. In step 108 a single bit in the 32 bit serial number is called up for examination. The present invention may be executed by examining the most significant bit in each processor first, or the least significant bit first. Provided that all the processors on a particular vehicle system proceed in the same order, the order of execution is arbitrary.

At step 110 the first bit is examined and it is determined whether or not that bit is a 1 or a 0. In FIG. 1, “SN” indicates serial number and “i” indicates a given bit within that serial number. “SN{i}” indicates the hard coded serial number bit at index i. In the depicted embodiment, if at step 110 the bit under consideration is a zero, the processor will drive the bus 40 to its low or 0 state. If the bit under consideration at step 110 is a 1, that individual processor will not drive the bus 40 low. In the depicted embodiment, in order to accommodate the electroactive properties of the hardware, a time out is incorporated at step 114 in order that the bus state, 1 or 0, may be conclusively determined.

Next at step 116, the processor 22, 24, 26 or 28 compares the state of the bit under consideration, SN{i}, to the state of the bus. If SN{i} is 0, this individual processor has already driven the bus low to value 0 and therefore at step 116 the comparison will yield a true value and thus the processor will proceed to step 118. However, if SN{i} is a 1 then SN{i} may or may not equal the state of the bus. If none of the processors have a 0 value at SN{i} then none of the processors will have driven the bus to the low, zero value state, leaving the buss 40 in the default state of 1. Under this circumstance SN{i} will equal the bus state and the process will move on to step 118. This occurs when all processors have a 1 at the bit under consideration. In this circumstance, no processor is distinguished from the other processors and the system will iterate; each processor will index the bit to be considered next and a designation as a master or slave processor will be deferred until a later iteration.

Decisively, however, if SN{i} for the processor depicted in FIG. 2 is 1 and any other processor in the vehicle system has a 0 value at SN{i}, then the buss 40 will have been driven by the other processor to a low or 0 state. Under this circumstance, at step 116 SN{i} will not equal the state of the bus. When this occurs, a no or false value is returned and this particular processor is designated as a slave at step 120. For this particular processor then, the arbitration routine is complete and stops at step 122.

By analogy, step 116 determines if any individual processor “wins” the comparison at step 116 to survive until the next iteration, or “loses” to be designated as a slave and be omitted from further iterations. By extension, through multiple iterations, it becomes evident that the arbitration routine is a process of finding the exclusive “0” state at a first indexed bit, and, in so finding the first processor having the exclusive 0, a master processor may be designated.

At step 118 those processors surviving the comparison step 116 check to see if the bit being considered is the final or 32^{nd} bit. This step 118 thereby creates an end to the arbitration routine. If the bit being considered in the current iteration is not the 32^{nd} bit then the surviving processors index to the next bit at step 124. Having done so, step 110 is repeated for the next index bit. This process repeats. Because each serial number for each processor within the system of the present invention is necessarily unique, there will necessarily be a processor having the first exclusive 0, and this processor will survive at step 116 in all iterations. When it reaches its 32^{nd} bit at step 118, the routine will be over and the singular surviving processor will be designated as the master processor at 126. Hence a master processor is isolated according to its first exclusive state relative to the other processors in the vehicle lighting system.

To further illustrate the arbitration routine, an example will be given. Assume that not 32 bits but 2 bits are used for the serial numbers. Assume further that processor 22 has a serial number of 00, processor 24 has a serial number of 01, processor 26 has a serial number of 10 and the processor 28 has a serial number of 11. Assume further that the system in the example is configured to proceed from the most significant bit to the least significant bit. During a first iteration, all four processors will designate the first, most significant bit on the left as SN{i}. Processor 22 has a 0 at this position. Accordingly, this will be recognized at step 110 and processor 1 will drive bus 40 low at step 112. Accordingly, bus 40 has the low voltage value of 0 for all four processors. Processor 22 will at step 116 compare its SN{i} to the state of the bus and determine that they are both 0. Accordingly, processor 22 will “survive” this iteration and move on to step 118 and 124. Processor 24 has a 0 at SN{i} and will likewise survive the present iteration and index to the next bit at step 124. However, processors 26 and 28 each have a 1 at SN{i}. Accordingly, when they reach step 116 they will compare their SN{i}, a 1, to the value of the bus 40, which is a 0 because it has been driven low by processors 22 and 24. Accordingly, step 116 will return a false or no value for processors 26 and 28. Hence, during this iteration processors 26 and 28 are designated as slaves at step 120 and for processors 26 and 28 the routine stops.

Processors 22 and 24 having indexed to their next bit at step 124, will proceed again to step 110. Processor 22 at step 110 will discover that its right hand bit, now SN{i} for this second iteration, is equal to 0. Accordingly, at step 112 it will drive the bus 40 low, to a 0 value. Processor 22 will then at step 116 compare its SN{i} to the bus state and find that they are equal and once again proceed to step 118. Processor 24, however, has an SN{i} of 1 at this bit. Accordingly, it will not drive the bus low and proceed directly to step 116. At step 116 processor 24 will discover that its SN{i} is not equal to the bus state and accordingly be designated as a slave at step 120, thereby ending its arbitration routine 122. This leaves an exclusive surviving processor, processor 22 having a 00 serial number, the first exclusive state. Because the simplified example has only two bits, step 118 would correspondingly have a final bit at 2 and therefore at step 118 processor 22 will have a yes value, be designated as the master at step 126, save this designation and end its arbitration routine. Those with skill in the art will recognize that whether a processor having a first exclusive 0 or first exclusive 1 state is designated as a “winner” at each iteration and remain a candidate to be the master, is arbitrary. The logic could apply equally well in either converse manner. Both are within the scope of the present invention.

Configuration Mode

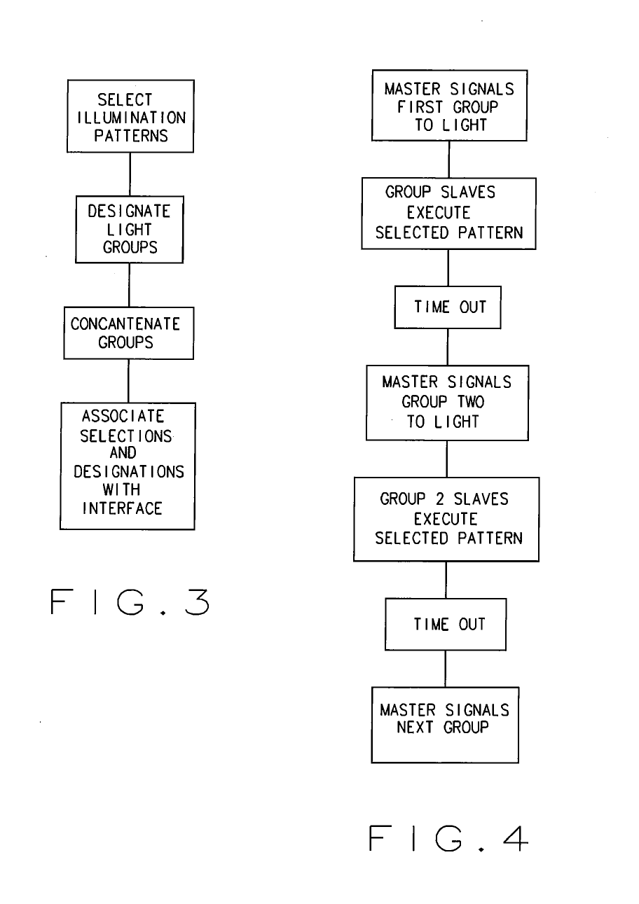

FIG. 3 depicts the configuration mode, by which a particular system of lights for a particular use, such as a vehicle, is installed and set up for use.

During manufacture, a plurality of flash or illumination patterns are preprogrammed in each processor for each light of the system of the present invention. The number of possible patterns is scalable.

Upon installation, any number of lights is installed, as for example on a vehicle. The control bus 40 is wired between the processors of all lights to be included in the system. A user interface is installed, as for example in the dash on the instrument panel of a vehicle and wired to be in operative communication with the processors through the bus 40. After the hardware is installed, the configuration mode may be entered by an installer.

As shown on FIG. 3, the installer may select a desired flash pattern or plurality of flash patterns. The installer may associate any of the lights in the vehicle light system with any of the other lights in the system as a group. The number of lights within a group is scalable. The number of groups is scalable. Because the illumination patterns the installer has to select from are preprogrammed in each processor associated with each light, and because groups are designated according to the unique identifiers within each processor associated with each light in the system, neither pattern selection nor group selection requires any additional wiring; all are ultimately executed through only control bus 40.

The installer may associate selected flash patterns or illumination patterns with each group. The patterns may be the same or different for each group.

The installer assigns in a user interface a mode to activate each of the selected patterns for each of the designated groups. Accordingly, in operation and by way of example and not limitation, a single mode button on a user interface 50 may be pressed repeatedly by the ultimate operator, as for example a driver, to initiate each particular selected illumination pattern for each designated group. It is within the scope of the invention that the vehicle light system be installed and configured without an operator interface, and that operation be thereafter limited to the selected illumination patterns and group designations defined in the processors at configuration.

Optionally, sequences of illumination may be concatenated by group such that a first selected pattern will be executed by a first group and thereafter, without any additional input by the operator through the operator interface, a second selected pattern may be executed by a second group. The concatenation of sequences and groups is scalable. Again, for each such concatenation of sequences and groups, a separate mode may be established at the operator interface.

Any of the lights in a vehicle light system may be put in a group, and lights may be established in any order, since the hardwired installation of the system does not itself require any particular order. Accordingly, as depicted in FIG. 1, LEDs 12 and 14 may be designated as a first group with 16 and 18 being a second group or, alternatively, 12 and 16 may be designated as a first group and 14 and 18 a second group, or, alternatively, 12 and 18 may be a first group and 14 and 16 a second group.

Each processor for each light in the vehicle lighting system is configured with the selected illumination patterns and group designations. By so doing, the system of the present invention insures continued operation of the vehicle light control system even if the master light processor is damaged. If the master processor is damaged, during the next arbitration mode it will no longer be on line, and the light/processor with the next exclusive state will be designated as the new master. Because all the processors in the vehicle light system are configured with the necessary illumination pattern and group designation data, any of them may serve as the master and run the operation mode.

Other Lights:

It is often desirable to incorporate pre-existing lights into the overall vehicle lighting control system. Other lights may include processor controlled lights that are provided from outside the system of the present invention, and therefore do not have a uniquely identifying serial number. Other lights may also include simple lights having no control processor. For example, some police forces prefer a warning flash pattern wherein the pre-existing automobile's headlights flash alternately, sometimes known as “wig-wags.” The system of the present invention provides for incorporating such lights into the vehicle light control system. In either case, the procedure is simply to provide a processor having a unique identifier from within the system of the present invention and associating it with the given light. Accordingly, add-on processor 60 may be hardwired into the system and installed in any convenient location. The add-on processor 60 would be hardwired to the given light 70, as depicted in FIG. 1. The add-on processor 60 would then be connected to the bus 40. Thereafter, configuration, arbitration and operation would proceed as described elsewhere herein and include the light 70.

Operational Mode:

In operation, an operator turns on the system. By so doing, the operator automatically initiates the arbitration mode. After the arbitration mode designates a master, the operator may enter through the operator interface 50 a mode which has been preconfigured to execute a selected illumination pattern by a designated group of lights. The master processor signals the first group of lights to execute the first pattern. The slaves in the first group of lights execute that pattern. A time-out is reached for that pattern. Thereafter, the master signals the second group to execute a second pattern. The slave processors in that group execute the second pattern. Another time-out is reached. The sequence may continue in a scalable fashion and may be configured to repeat.

Advantageously, because each processor is programmed with selected flash patterns, if the master is broken, the slaves will continue to execute the selected flash patterns, even before a new arbitration.

Wireless Systems

Those of skill in the art will recognize that the system of the present invention in all its modes is executed through the transfer of digitized data. Accordingly, it is within the scope of the present invention to transmit that data according to any method. This includes wireless transfer modes, such as, by way of example and not limitation, radio frequency transmission. In such an embodiment of the invention, even the bus 40 may be advantageously obviated. To do so, each light/processor unit would include a transceiver 240, as shown in FIG. 5. In the depicted embodiment, the RF transceivers 240 would transmit to one another either steady 1s or steady 0s through each iteration of the arbitration mode, and the processors 222, 224, 226 and 228 interact with it in the same fashion described above by which they would interact with a wire bus. In this way, the invention may be advantageously installed in broader applications than a vehicle, for example multiple vehicles, airports, mines, oil rigs and the like.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of controlling a plurality of lights on a vehicle lighting system, said method comprising:
providing a first light and a second light;
providing a first processor and a second processor, each of said first and second processors being in operative communication with a respective one of said first light and said second light;
providing a bus;
establishing an operative communication between each of said first processor and second processor and said bus;
arbitrating a master processor among said first processor and second processor;
said processor being arbitrated as a master processor thereafter signaling each of said first processor and second processor to execute a preconfigured flash pattern.

2. The method of claim 1 further comprising:
associating a third light having a third processor with one of said first light and first processor or said second light and second processor in a group;
providing a third light having a third processor;
establishing an operative communication between said third processor and said bus;
such that at least one of said preconfigured flash patterns is executed by said group;
